(19) United States
(12) Patent Application Publication
(10) Pub. No.: US 2021/0073391 A1
(43) Pub. Date: Mar. 11, 2021

(54) METHODS AND APPARATUS TO IMPROVE SECURITY OF COMPUTER PROGRAMS USING CODE ABSTRACTION

(71) Applicant: Intel Corporation, Santa Clara, CA (US)

(72) Inventor: Justin Gottschlich, Santa Clara, CA (US)

(21) Appl. No.: 17/098,133

(22) Filed: Nov. 13, 2020

Related U.S. Application Data
(60) Provisional application No. 62/941,668, filed on Nov. 27, 2019.

(51) Int. Cl. G06F 21/57; G06F 8/51; G06F 21/55

(52) U.S. Cl. CPC G06F 21/577; G06F 2221/033; G06F 21/554; G06F 8/51

(57) ABSTRACT

Methods, apparatus, systems, and articles of manufacture are disclosed to improve security of computer programs using code abstraction. An example method includes parsing a first representation of an algorithm in a base language for an operator associated with the base language; based on the operator, identifying a vulnerability in the first representation of the algorithm; identifying a target language to represent the algorithm; and converting the first representation of the algorithm in the base language to a second representation of the algorithm in the target language to remediate the vulnerability.

### RELATED APPLICATION

This patent arises from an application claiming the benefit of U.S. Provisional Patent Application Ser. No. 62/941,668, which was filed on Nov. 27, 2019. U.S. Provisional Patent Application Ser. No. 62/941,668 is hereby incorporated herein by reference in its entirety. Priority to U.S. Provisional Patent Application Ser. No. 62/941,668 is hereby claimed.

### FIELD OF THE DISCLOSURE

This disclosure relates generally to programming security, and, more particularly, to methods and apparatus to improve security of computer programs using code abstraction.

### BACKGROUND

Computer programmers develop programs that can be run on a variety of hardware components of a computer platform. Computer programmers also develop programs using a variety of programming languages (e.g., assembly language, Fortran, C, C#, C++, Objective-C, Java, Python, JavaScript, Ruby, Perl, etc.). The particular programming language a computer programmer may elect to use depends on a variety of factors including the purpose of the program itself, the computer programmer's experience, development and maintenance considerations, the hardware of a target platform(s) on which the program will run, and/or software with which the program will interact. Computer programmers often develop programs using an integrated development environment (IDE) which includes a source code editor, program build automation tools, a debugger, a compiler, and/or an interpreter.

### BRIEF DESCRIPTION OF THE DRAWINGS

FIG. 1 is a block diagram of an example computing environment to improve security of computer programs using code abstraction.

FIG. 2 is a block diagram of an example security controller included in the example computing environment of FIG. 1.

FIG. 3 is a flowchart representative of example machine readable instructions which may be executed to implement the example security controller of FIGS. 1 and 2 to generate an example secure representation of an algorithm in an example target programming language.

FIG. 4 is a flowchart representative of example machine readable instructions which may be executed to implement the example security controller of FIGS. 1 and 2 to convert a base programming language representation of an algorithm to a secured target programming language representation of the algorithm.

FIG. 5 is a block diagram of an example processing platform structured to execute the instructions of FIGS. 3 and 4 to implement the security controller of FIGS. 1 and 2.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

When developing software, a computer programmer may desire to develop a program that can be run on multiple hardware platforms such as, for example, a graphics processing unit (GPU), a vision processing unit (VPU), a central processing unit (CPU), or a field-programmable gate array (FPGA). To develop programs that can be run on multiple hardware platforms, computer programmers can rely on a technique known as verified lifting. Verified lifting leverages domain specific languages (DSLs). For example, when utilizing verified lifting, a computer programmer can represent an algorithm originally programmed in a general-purpose language (e.g., C, C#, Java, etc.) as high-level, abstract, representation of the algorithm using a DSL (e.g., Halide, OpenCL, etc.). DSLs separate how an algorithm (e.g., a program, a block of code, etc.) is written from how the algorithm is executed (e.g., separation of concerns). For example, many DSLs allow a developer to represent an algorithm in a high-level functional language without worrying about the performant mapping of the algorithm to the underlying hardware and also allows the developer to implement and explore high-level strategies to map the algorithm to the hardware (e.g., by a process called schedule specification) to obtain a performant implementation. Additionally, some DSLs separate the algorithm being run from how the storage of a hardware platform is utilized to store the input and/or output data.

For example, an algorithm may be defined to blur an image (e.g., how the algorithm is written) and a developer may desire that the algorithm run effectively on a CPU, a VPU, a GPU, and an FPGA. To effectively run the algorithm on the various types of hardware platforms (e.g., CPU, VPU, GPU, FPGA, a heterogeneous system, etc.), a computer programmer and/or IDE/DSL will generate a schedule. For example, the schedule can define how the program maps to a hardware platform. Many methods of automating compilation time scheduling of an algorithm have been developed. For example, compilation auto-scheduling, may include auto-tuning, heuristic searching, and hybrid scheduling.

While verified lifting has been used as a technique to increase performance of algorithms across multiple forms of hardware, the same cannot be said regarding algorithmic security. When a computer programmer develops a program for a particular hardware platform in a particular language, the program may or may not rely on specific hardware security features and/or programming language security features that prevent vulnerabilities (e.g., cache-based side channel attacks, buffer overruns, invalid pointer dereferences, third-party application programming interface (API) calls using opaque data structures, etc.) of that hardware and/or in that programming language. For example, a less experienced programmer may use an unsafe (e.g., less secure) syntax to check the value at a position in a container, whereas a more experienced programmer may use a safe (e.g., more secure) syntax to do the same. For example, in C++, the safe syntax can be std::vector.at( ) which checks to make sure the requested position is within the container and the unsafe syntax can be std::vector[ ] which does not check to make sure the requested position is within the container.

If a less experienced programmer uses an unsafe syntax, the program they have written is subject to vulnerabilities that can be exploited by nefarious entities and/or malicious code. Likewise, even if a programmer is experienced with a particular programming language and/or a particular hardware platform, when the program is transferred into another language and/or compiled to be run on another hardware platform, the security features of the base programming language (BPL) and base hardware platform (BHP) are not necessarily maintained for the target programming language (TPL) and target hardware platform (THP).

Examples disclosed herein include methods and apparatus to improve security of computer programs using code abstraction. Examples disclosed herein include an example method to improve security of computer programs using code abstraction, the method comprising: parsing a first representation of an algorithm in a base language for an operator associated with the base language; based on the operator, identifying a vulnerability in the first representation of the algorithm; identifying a target language to represent the algorithm; and converting the first representation of the algorithm in the base language to a second representation of the algorithm in the target language to remediate the vulnerability. For example, converting the first representation of the algorithm in the base language to the second representation of the algorithm in the target language can include generating a third representation of the algorithm in a domain specific language, identifying potential vulnerabilities associated with the target language, and generating domain specific language syntax to secure the potential vulnerabilities associated with the target programming language by performing lambda calculus operations.

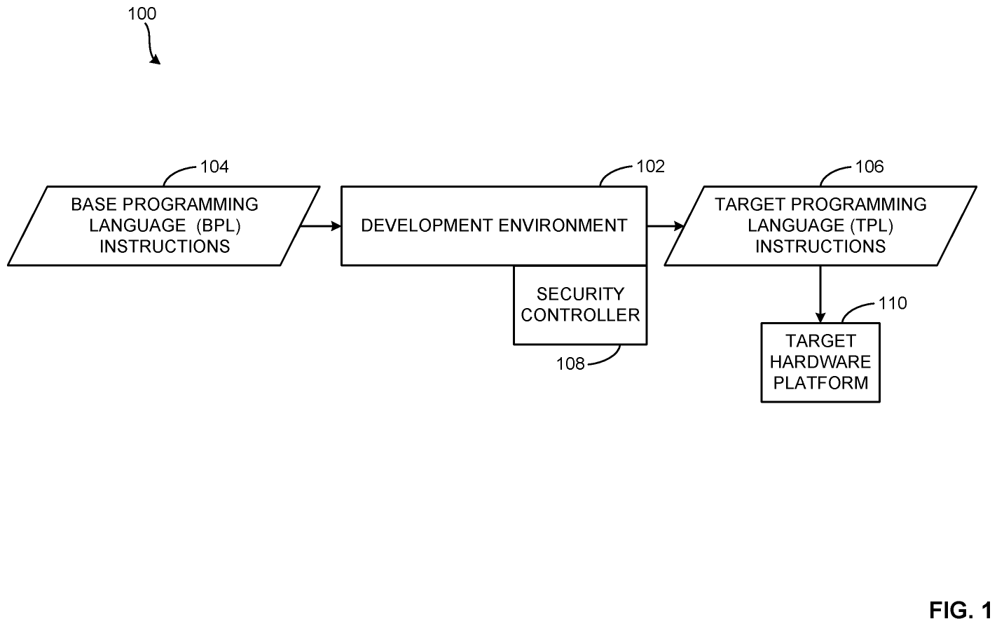

FIG. 1 is a block diagram of an example computing environment 100 to improve security of computer programs using code abstraction. The example computing environment 100 includes an example development environment 102 which can be implemented by a computer that executes a computer-based program that converts an example algorithm represented by example base programming language (BPL) instructions 104 (e.g., a base language representation) into an example secured version of the algorithm represented by example target programming language (TPL) instructions 106 (e.g., a target language representation). The example computing environment 100 additionally includes an example security controller 108 which can generate the secured version of the algorithm represented by the example TPL instructions 106. In the example of FIG. 1, the example BPL instructions 104 can correspond to instructions prepared using a programming language such as C, C++, Java, etc. In the example of FIG. 1, the example TPL instructions 106 can correspond to an alternate programming language other than the BPL instructions 104. In some examples, the TPL instructions 106 can correspond to the same programming language as the BPL instructions 104.

In the illustrated example of FIG. 1, the development environment 102 receives and/or otherwise obtains the example BPL instructions 104 from a user (e.g., a programmer, a developer, etc.), a software application, a computing device including one or more processors, etc., and/or a combination thereof. In the example of FIG. 1, the development environment 102 can be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). In some examples, the development environment 102 can be implemented as a software application.

In some examples, the development environment 102 verifies syntax of the BPL instructions 104 according to the base programming language (e.g., C, C++, Java, Python, etc.). For statically-typed languages, the example development environment 102 can perform type checking by collecting type information. For example, if an input program corresponding to the BPL instructions 104 is syntactically incorrect or has a type error (e.g., a typographical error), then the development environment 102 can generate error(s) and/or warning(s).

Additionally or alternatively, the development environment 102 can include the functionality to edit source code of a computer program and/or algorithm. The development environment 102 can create one or more software builds which can include compiling source code into binary code, packaging binary code, and/or running automated tests. For example, the development environment 102 can facilitate debugging and/or testing of programs. In some examples, the development environment 102 can execute programs without compiling the programs.

In the example of FIG. 1, the example computing environment 100 includes the security controller 108. The security controller 108 is configured to convert the algorithm represented by the BPL instructions 104 to a secured version of the algorithm represented by the TPL instructions 106. In the example of FIG. 1, the security controller 108 can be implemented by one or more analog or digital circuit(s), logic circuits, programmable processor(s), programmable controller(s), GPU(s), DSP(s), ASIC(s), PLD(s) and/or FPLD(s). In some examples, the security controller 108 can be implemented as a plugin to the development environment 102.

In the illustrated example of FIG. 1, the security controller 108 is configured to identify an algorithm represented by the BPL instructions 104 (e.g., the BPL instructions 104 and/or a portion thereof) that is a candidate to be secured via examples disclosed herein. For example, the security controller 108 can identify an algorithm that is compatible with a DSL. For example, algorithms that are compatible with DSLs can include algorithms that are specialized to a particular application (e.g., image processing, audio processing, etc.). In some examples, the DSL is a pre-existing DSL (e.g., Halide, OpenCL, Emacs Lisp, OpenGL, Shading Language, etc.). In other examples, the DSL can be developed to be utilized with examples disclosed herein. For example, a human expert can develop a new DSL to be utilized with a particular type of algorithm. In other examples, a program and/or other software can develop a DSL to be utilized with a particular type of algorithm.

In the illustrated example of FIG. 1, the security controller 108 is configured to perform lexical analysis, semantic analysis, syntax analysis, etc., and/or a combination thereof on the BPL instructions 104. For example, the security controller 108 can identify semantics of the BPL instructions 104 (e.g., the intent of the BPL instructions 104, the goals associated with the BPL instructions 104, etc.). In additional or alternative examples, the security controller 108 can parse the BPL instructions 104 for native BPL operators, native BPL libraries/APIs, and/or third-party libraries/APIs. For example, in C++, native operators can include ==, <, =, !=, etc. In C++, native libraries/APIs can include floating point libraries (e.g., cfenv (fenv.h), cfloat (float.h), etc.), numerics libraries (e.g., cmath (math.h)), libraries to handle signals (e.g., csignal (signal.h)), etc. In C++, third-party libraries/APIs can include Boost, Intel's MKL, etc.

In the example illustrated in FIG. 1, the security controller 108 is configured to identify the BPL in which the algorithm (e.g., the BPL instructions 104) is programmed. The security controller 108 is further configured to identify a BHP on which to execute the BPL representation of an algorithm (e.g., the BPL instructions 104). For example, the security controller 108 can identify the BPL and/or the BHP based on user-provided parameters extracted by the development environment 102. In some examples, the security controller 108 can identify the BHP based on a model number of the BHP. In other examples, the security controller 108 can identify the BPL and/or the BHP via any suitable technique.

In the example of FIG. 1, the security controller 108 is configured to identify vulnerabilities associated with the BPL instructions 104 and/or the BHP. For example, based on native BPL operators, native BPL libraries/APIs, and/or third-party libraries/APIs identified when parsing the BPL instructions 104, the security controller 108 can identify one or more vulnerabilities in the BPL instructions 104. For example, when the BPL is C++, vulnerabilities associated with the BPL can include buffer overruns, invalid pointer dereferences, third-party API calls using opaque data structures, use of optimized versions of third-party APIs, etc. Additionally or alternatively vulnerabilities associated with the BPL can include network vulnerabilities related to memory. For example, when using optimized version of third-party APIs, the optimization may target a hardware platform other than the THP and/or a programming language other than the TPL. As such, the optimized versions of third-party APIs may lead to vulnerabilities. In additional or alternative examples, the security controller 108 can identify security vulnerabilities associated with the BHP based on one or more known vulnerabilities associated with the BHP. For example, the security controller 108 can access a database including security vulnerabilities associated with various hardware platforms. Vulnerabilities associated with the BHP can include cache-based side channel attacks using shared caches and instruction speculation. The security controller 108 can identify the security vulnerabilities of the BPL instructions 104 based on the syntax of the BPL instructions 104 and/or how the BPL instructions utilize the BHP.

In the example illustrated in FIG. 1, the security controller 108 is configured to identify the TPL (e.g., the TPL instructions 106) in which the algorithm (e.g., algorithm represented by the BPL instructions 104) is to be programmed. The security controller 108 is further configured to identify a THP on which to execute the TPL representation of an algorithm (e.g., the TPL instructions 106). For example, the security controller 108 can identify the TPL and/or the THP based on user-provided parameters extracted by the development environment 102. In some examples, the security controller 108 can identify the THP based on a model number of the THP. In other examples, the security controller 108 can identify the TPL and/or the THP via any suitable technique. In some examples, the THP can be a device different than the BHP (e.g., an example target hardware platform (THP) 110). For example, the TPL instructions 106 can correspond to machine readable instructions that are specific for a target CPU architecture corresponding to the example THP 110. In other examples, the THP can be the BHP.

In the example of FIG. 1, the security controller 108 is further configured to convert the algorithm represented by the BPL instructions 104 to a secured version of the algorithm represented by the TPL instructions 106. The security controller 108 is additionally configured to determine whether BPL is the same as the TPL (e.g., converting insecure code in C++ to secure code in C++). In response to the BPL being different than the TPL, the security controller 108 can convert the algorithm represented by the BPL instructions 104 to a high-level, DSL representation of the algorithm. Additionally or alternatively, the security controller 108 can identify potential vulnerabilities associated with the TPL. For example, the security controller 108 can access a database include known vulnerabilities associated with the TPL. In such an example, the security controller 108 can additionally or alternatively generate DSL syntax to secure the TPL vulnerabilities by performing lambda calculus.

In the illustrated example of FIG. 1, the security controller 108 is configured to determine whether the BHP is the same as the THP (e.g., converting insecure code to be executed at an Intel Xeon processor to secure code to be executed at an Intel Xeon processor). In response to the BHP being different than the THP, the security controller 108 can determine whether the algorithm has previously been converted from the BPL instructions 104 to a high-level, DSL representation of the algorithm. In response to determining that the algorithm has not been previously converted from the BPL instructions 104 to a high-level, DSL representation of the algorithm, the security controller 108 can convert the BPL instructions 104 to a high-level, DSL representation of the algorithm. In response to determining that the algorithm has been previously converted from the BPL instructions 104 to a high-level, DSL representation of the algorithm, the security controller 108 can identify potential vulnerabilities associated with the THP. For example, the security controller 108 can access a database include known vulnerabilities associated with the THP. For example, the known vulnerabilities associated with the THP can be identified based on a model number of the THP. In such an example, the security controller 108 can additionally or alternatively generate DSL syntax to secure the THP vulnerabilities by performing lambda calculus. By performing lambda calculus, the security controller 108 can identify programmatic elements in the a TPL representation (e.g., for loops, while loops, do while loops, etc.) of the security vulnerability and generalize the programmatic elements (e.g., loops generally). Performing lambda calculus also allows the security controller 108 to expand a DSL to be utilized in conjunction with BPL instructions 104 and/or the TPL instructions 106 to generate new DSL operations to accommodate security vulnerabilities associated with TPL and/or the THP. Lambda calculus additionally reduces the computational search space for recreating code in a lower level language (e.g., the TPL instructions 106).

In the example of FIG. 1, after generating DSL syntax to secure potential vulnerabilities associated with the TPL and/or DSL syntax to secure potential vulnerabilities associated with the THP, the security controller 108 can generate a TPL representation of the secured algorithm (e.g., the TPL instructions 106). For example, the security controller 108 can generate a target language representation of the algorithm that remediates the vulnerabilities associated with the TPL and/or the THP. Additionally or alternatively, if the TPL and the THP are the same as the BPL and the BHP, respectively, the security controller 108 can generate the TPL representation of the secured algorithm (e.g., the TPL instructions 106) by remediating the vulnerabilities of the insecure BPL instructions (e.g., the BPL instructions 104) with secure BPL instructions. For example, if the security controller 108 secures an algorithm written in in a base language of C++ with a target language of C++, secure syntax to check the value at a position in a container can be std::vector.at( ) which checks to make sure the requested position is within the container and insecure syntax can be std::vector[ ] which does not check to make sure the requested position is within the container. To generate TPL representations of a secured algorithm, the security controller 108 can generate a mapping between the DSL representation of the algorithm to the TPL representation of the secured algorithm. Alternatively, when the TPL and the BPL are the same, the security controller 108 can generate a mapping between the insecure (e.g., unsafe) syntax in the BPL and the secure (e.g., safe) syntax in the BPL.

In additional or alternative examples, a C++ programming language vulnerability can include buffer overruns. To remediate this potential programming vulnerability in C++, the security controller 108 can generate DSL syntax that maps to an instantiation of a safe C++ data structure that emits exceptions for illegal data structure overruns (e.g., std::vector.at( )). Furthermore, a C++ programming language vulnerability can include dereferenced pointers. To remediate this potential programming vulnerability in C++, the security controller 108 can generate DSL syntax that maps to an instantiation of a C++ smart pointer which emits exceptions on illegal accesses (e.g., std::smart_ptr). Additionally or alternatively, a hardware platform vulnerability can include cache-based side channel attacks via instruction speculation. To remediate this potential hardware platform vulnerability, the security controller 108 can generate DSL syntax that implements memory fences in the TPL instructions 106 before accessing secure data. Such a memory fence effectively eliminates the CPU from performing instruction speculation on the secure data.

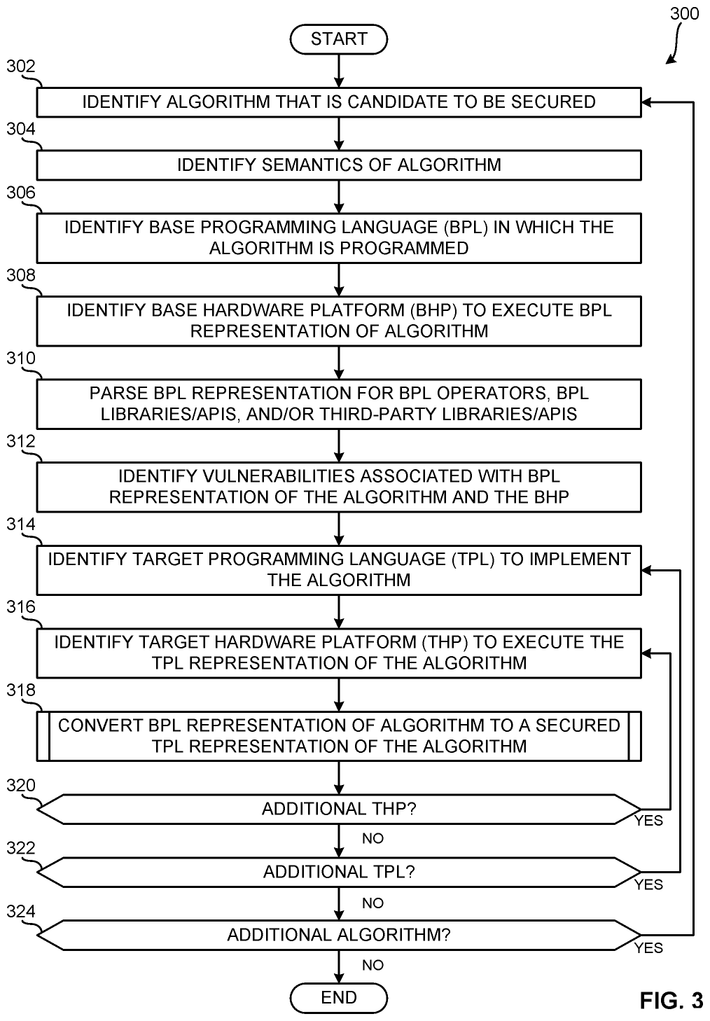

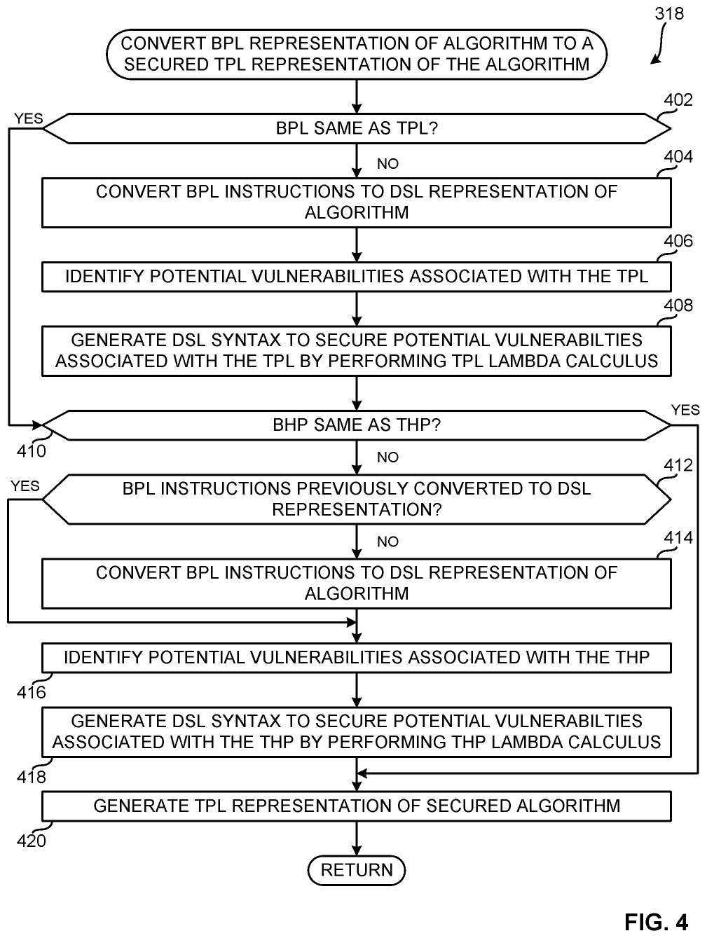

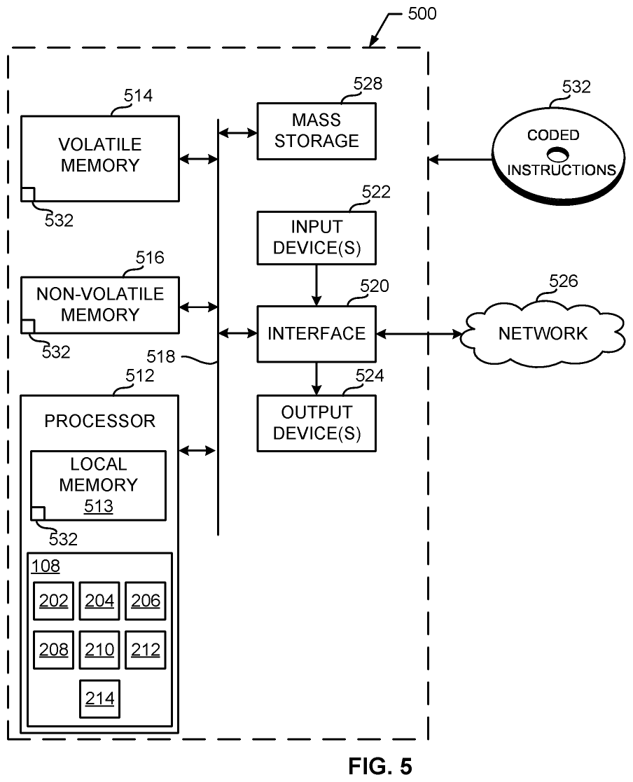

In some examples, the example security controller 108 implements example means for securing code. The code securing means is implemented by executable instruction such as that illustrated by at least blocks 302, 304, 306, 308, 310, 312, 314, 316, 318, 320, 322, and 324 of FIG. 3, and/or at least blocks 402, 404, 406, 408, 410, 412, 414, 416, 418, and 420 of FIG. 4, which may be executed on at least one processor such as the example processor 512 shown in the example of FIG. 5. In other examples, the code securing means is implemented by hardware logic, hardware implemented state machines, logic circuitry, and/or any other combination of hardware, software, and/or firmware.

In the example of FIG. 1, the TPL instructions 106 can be executed at the example THP 110. The example THP 110 can be, for example, a server, a personal computer, a workstation, a mobile device (e.g., a cell phone, a smart phone, a tablet such as an iPad™), or any other type of computing device that includes one or more processors. The TPL instructions 106 generated by the example security controller 108 can correspond to machine-readable instructions specialized and/or otherwise tailored for a particular processor and/or operating system included in the example THP 110. For example, the THP 110 may execute the TPL instructions 106 that are generated based on the examples disclosed herein.

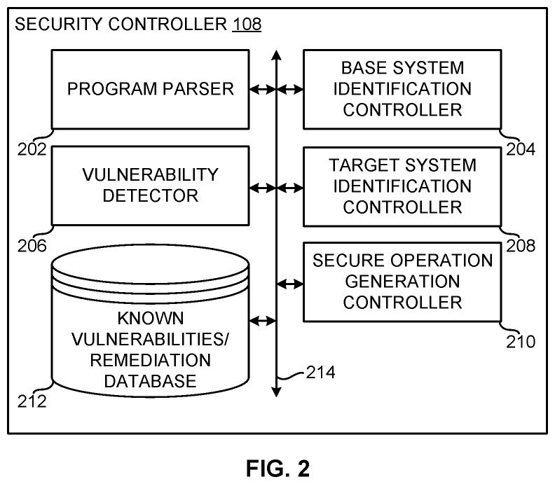

FIG. 2 is a block diagram of the example security controller 108 included in the example computing environment 100 of FIG. 1. The example security controller 108 includes an example program parser 202, an example base system identification controller 204, an example vulnerability detector 206, and example target system identification controller 208, an example secure operation generation controller 210, and an example known vulnerabilities and/or known remediation database 212. In the example of FIG. 2, any of the program parser 202, the base system identification controller 204, the vulnerability detector 206, the target system identification controller 208, the secure operation generation controller 210, and/or the known vulnerabilities and/or known remediation database 212 may communicate via an example communication bus 214. In examples disclosed herein, the communication bus 214 may be implemented using any suitable wired and/or wireless communication.

In the example of FIG. 2, the example security controller 108 includes the example program parser 202. The program parser 202 is configured to parse programs (e.g., the BPL instructions 104) to identify information associated with the programs. In the example of FIG. 2, the program parser 202 can be implemented by one or more analog or digital circuit(s), logic circuits, programmable processor(s), programmable controller(s), GPU(s), DSP(s), ASIC(s), PLD(s) and/or FPLD(s).

In the illustrated example of FIG. 2, the program parser 202 is configured to identify an algorithm represented in a BPL (e.g., the BPL instructions 104 and/or a portion thereof) that is a candidate to be secured via examples disclosed herein. The program parser 202 can identify an algorithm as a candidate if the algorithm is compatible with a DSL. The program parser 202 is additionally or alternatively configured to perform lexical analysis, semantic analysis, syntax analysis, etc., and/or a combination thereof on programs (e.g., the BPL instructions 104). The program parser 202 can identify semantics of the BPL instructions 104 (e.g., the intent of the BPL instructions 104, the goals associated with the BPL instructions 104, etc.). Additionally, the program parser 202 can parse the programs (e.g., the BPL instructions 104) for native BPL operators, native BPL libraries/APIs, and/or third-party libraries/APIs.

In some examples, the example program parser 202 implements example means for parsing a program. The program parsing means is implemented by executable instruction such as that illustrated by at least blocks 302, 304, 310, and 324 of FIG. 3, which may be executed on at least one processor such as the example processor 512 shown in the example of FIG. 5. In other examples, the program parsing means is implemented by hardware logic, hardware implemented state machines, logic circuitry, and/or any other combination of hardware, software, and/or firmware.

In the example illustrated in FIG. 2, the security controller 108 includes the example base system identification controller 204. In the example of FIG. 2, the base system identification controller 204 can be implemented by one or more analog or digital circuit(s), logic circuits, programmable processor(s), programmable controller(s), GPU(s), DSP(s), ASIC(s), PLD(s) and/or FPLD(s). The example base system identification controller 204 is configured to identify the BPL in which the algorithm (e.g., the BPL instructions 104) is programmed. The base system identification controller 204 is further configured to identify a BHP on which to execute the BPL representation of an algorithm (e.g., the BPL instructions 104). For example, the base system identification controller 204 can identify the BPL and/or the BHP based on user-provided parameters extracted by the development environment 102. In some examples, the base system identification controller 204 can identify the BHP based on a model number of the BHP. In other examples, the base system identification controller 204 can identify the BPL and/or the BHP via any suitable technique. The base system identification controller 204 is additionally or alternatively configured to identify whether the BPL is the same as the TPL and/or whether the BHP is the same as the THP. In some examples, the base system identification controller 204 can determine whether the BPL is within a threshold of similarity to a TPL and/or whether the BHP is within a threshold of similarity to a THP.

In some examples, the example base system identification controller 204 implements example means for identifying a base system. The base system identifying means is implemented by executable instruction such as that illustrated by at least blocks 306 and 308 of FIG. 3, and/or at least blocks 402 and 410 of FIG. 4, which may be executed on at least one processor such as the example processor 512 shown in the example of FIG. 5. In other examples, the base system identifying means is implemented by hardware logic, hardware implemented state machines, logic circuitry, and/or any other combination of hardware, software, and/or firmware.

In the example of FIG. 2, the security controller 108 includes the example vulnerability detector 206. In the example of FIG. 2, the vulnerability detector 206 can be implemented by one or more analog or digital circuit(s), logic circuits, programmable processor(s), programmable controller(s), GPU(s), DSP(s), ASIC(s), PLD(s) and/or FPLD(s). The example vulnerability detector 206 is configured to identify vulnerabilities associated with the BPL representation of an algorithm (e.g., the BPL instructions 104) and/or the BHP on which the BPL representation of the algorithm (e.g., the BPL instructions 104) is to run. For example, based on native BPL operators, native BPL libraries/APIs, and/or third-party libraries/APIs identified by the program parser 202 when parsing the BPL representation of the algorithm (e.g., the BPL instructions 104), the vulnerability detector 206 can identify one or more vulnerabilities in the BPL representation of the algorithm (e.g., the BPL instructions 104). In additional or alternative examples, the vulnerability detector 206 can identify security vulnerabilities associated with the BHP based on one or more known vulnerabilities associated with the BHP. For example, the vulnerability detector 206 can access the known vulnerabilities and/or known remediation database 212 to identify security vulnerabilities associated with the BHP. Vulnerabilities associated with the BHP can include cache-based side channel attacks using shared caches and instruction speculation. The vulnerability detector 206 can identify the security vulnerabilities of the BPL representation of an algorithm (e.g., the BPL instructions 104) based on the syntax of the BPL representation of the algorithm and/or how the BPL instructions utilize the BHP.

In the example of FIG. 2, the vulnerability detector 206 is configured to identify potential vulnerabilities associated with the TPL. For example, the vulnerability detector 206 can access the known vulnerabilities and/or known remediation database 212. The vulnerability detector 206 can additionally or alternatively identify potential vulnerabilities associated with the THP. For example, the vulnerability detector 206 can access the known vulnerabilities and/or known remediation database 212. For example, the known vulnerabilities associated with the THP can be identified based on a model number of the THP. In some examples, if the vulnerability detector 206 detects and/or otherwise identifies vulnerabilities associated with the BPL, BHP, TPL, and/or THP, the vulnerability detector 206 can add the detected vulnerabilities and/or associated remedies to the known vulnerabilities and/or known remediation database 212. For example, a human expert can identify zero-day vulnerabilities and add the vulnerabilities and/or associated remedies to the known vulnerabilities and/or known remediation database 212.

In some examples, the example vulnerability detector 206 implements example means for detecting vulnerabilities. The vulnerability detecting means is implemented by executable instruction such as that illustrated by at least block 312 of FIG. 3, and/or at least blocks 406 and 416 of FIG. 4, which may be executed on at least one processor such as the example processor 512 shown in the example of FIG. 5. In other examples, the vulnerability detecting means is implemented by hardware logic, hardware implemented state machines, logic circuitry, and/or any other combination of hardware, software, and/or firmware.

In the example illustrated in FIG. 2, the security controller 108 includes the example target system identification controller 208. In the example of FIG. 2, the target system identification controller 208 can be implemented by one or more analog or digital circuit(s), logic circuits, programmable processor(s), programmable controller(s), GPU(s), DSP(s), ASIC(s), PLD(s) and/or FPLD(s). The example target system identification controller 208 is configured to identify the TPL in which the algorithm (e.g., algorithm represented by the BPL instructions 104) is to be programmed. The target system identification controller 208 is further configured to identify a THP on which to execute the TPL representation of an algorithm (e.g., the TPL instructions 106). For example, the target system identification controller 208 can identify the TPL and/or the THP based on user-provided parameters extracted by the development environment 102. In some examples, the target system identification controller 208 can identify the THP based on a model number of the THP. In other examples, the target system identification controller 208 can identify the TPL and/or the THP via any suitable technique.

In some examples, the example target system identification controller 208 implements example means for identifying a target system. The target system identifying means is implemented by executable instruction such as that illustrated by at least blocks 314, 316, 320, and 322 of FIG. 3, which may be executed on at least one processor such as the example processor 512 shown in the example of FIG. 5. In other examples, the target system identifying means is implemented by hardware logic, hardware implemented state machines, logic circuitry, and/or any other combination of hardware, software, and/or firmware.

In the example of FIG. 2, the security controller 108 includes the example secure operation generation controller 210. In the example of FIG. 2, the secure operation generation controller 210 can be implemented by one or more analog or digital circuit(s), logic circuits, programmable processor(s), programmable controller(s), GPU(s), DSP(s), ASIC(s), PLD(s) and/or FPLD(s). The example secure operation generation controller 210 is configured to determine whether the BPL instructions 104 have been lifted and/or converted to a high-level, DSL representation of the algorithm. The secure operation generation controller 210 can additionally or alternatively convert the BPL instructions 104 to a high-level, DSL representation of the algorithm. For example, the secure operation generation controller 210 can generate a mapping between the BPL instructions 104 and higher-level, DSL syntax that achieves the semantics of the BPL instructions 104. For example, the secure operation generation controller 210 can access the known vulnerability and/or known remediation database 212, to determine a mapping between the BPL instructions 104 and a higher-level DSP representation of the algorithm.

The example secure operation generation controller 210 is further configured to generate DSL syntax to secure the TPL vulnerabilities identified by the vulnerability detector 206 by performing lambda calculus. Additionally or alternatively, the secure operation generation controller 210 can be configured to generate DSL syntax to secure the THP vulnerabilities by performing lambda calculus. By performing lambda calculus, the secure operation generation controller 210 can identify programmatic elements in the a TPL representation (e.g., for loops, while loops, do while loops, etc.) of the security vulnerability and generalize the programmatic elements (e.g., loops generally). Performing lambda calculus also allows the secure operation generation controller 210 to expand a DSL to be utilized in conjunction with a BPL (e.g., the BPL instructions 104) and/or a TPL (e.g., the TPL instructions 106) to generate new DSL operations to accommodate security vulnerabilities associated with TPL and/or the THP. Lambda calculus additionally reduces the computational search space for recreating code in a lower level language (e.g., the TPL instructions 106).

In the example of FIG. 2, after generating DSL syntax to secure potential vulnerabilities associated with the TPL and/or DSL syntax to secure potential vulnerabilities associated with the THP, the secure operation generation controller 210 can generate a TPL representation of the secured algorithm (e.g., the TPL instructions 106). For example, the secure operation generation controller 210 can generate a target language representation of the algorithm that remediates the vulnerabilities associated with the TPL and/or the THP. Additionally or alternatively, if the TPL and the THP are the same as the BPL and the BHP, respectively, the secure operation generation controller 210 can generate the TPL representation of the secured algorithm (e.g., the TPL instructions 106) by remediating the vulnerabilities of the insecure BPL instructions (e.g., the BPL instructions 104) with secure BPL instructions. To generate TPL representations of a secured algorithm, the secure operation generation controller 210 can generate a mapping between the DSL representation of the algorithm to the TPL representation of the secured algorithm. Alternatively, when the TPL and the BPL are the same, the secure operation generation controller 210 can generate a mapping between the insecure (e.g., unsafe) syntax in the BPL and the secure (e.g., safe) syntax in the BPL.

In some examples, the example secure operation generation controller 210 implements example means for generating secure operations. The secure operation generating means is implemented by executable instruction such as that illustrated by at least blocks 404, 408, 412, 414, 418, and 420 of FIG. 4, which may be executed on at least one processor such as the example processor 512 shown in the example of FIG. 5. In other examples, the secure operation generating means is implemented by hardware logic, hardware implemented state machines, logic circuitry, and/or any other combination of hardware, software, and/or firmware.

In the example of FIG. 2, the security controller 108 includes the example known vulnerabilities and/or known remediation database 212. The known vulnerabilities and/or known remediation database 212 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The known vulnerabilities and/or known remediation database 212 may additionally or alternatively be implemented by one or more double data rate (DDR) memories, such as DDR, DDR2, DDR3, DDR4, mobile DDR (mDDR), etc. The known vulnerabilities and/or known remediation database 212 may additionally or alternatively be implemented by one or more mass storage devices such as hard disk drive(s), compact disk drive(s), digital versatile disk drive(s), solid-state disk drive(s), etc. While in the illustrated example the known vulnerabilities and/or known remediation database 212 is illustrated as a single database, the known vulnerabilities and/or known remediation database 212 may be implemented by any number and/or type(s) of databases. Furthermore, the data stored in the known vulnerabilities and/or known remediation database 212 may be in any data format such as, for example, binary data, comma delimited data, tab delimited data, structured query language (SQL) structures, etc.

In the example FIG. 2, the known vulnerabilities and/or known remediation database 212 is an organized collection of data, stored on a computational system that is electronically accessible. For example, the known vulnerabilities and/or known remediation database 212 may be stored on a server, a desktop computer, an HDD, an SSD, or any other suitable computing system. The known vulnerabilities and/or known remediation database 212 can store potential vulnerabilities associated multiple programming languages and/or multiple hardware platforms. For example, the known vulnerabilities and/or known remediation database 212 can store one or more look-up-tables (LUTs). For example, for each programming language, the known vulnerabilities and/or known remediation database 212 can include a LUT which associates a known potential vulnerability (e.g., std::vector[ ] for C++) with a known remedy for the potential vulnerability (e.g., std::vector.at( ) for C++). Additionally or alternatively, for each hardware platform, the known vulnerabilities and/or known remediation database 212 can include a LUT which associates a known potential vulnerability (e.g., cache-based side channel attacks via instruction speculation) with a known remedy for the potential vulnerability (e.g., use of memory fences).

While an example manner of implementing the security controller 108 of FIG. 1 is illustrated in FIG. 2, one or more of the elements, processes and/or devices illustrated in FIG. 2 may be combined, divided, re-arranged, omitted, eliminated and/or implemented in any other way. Further, the example program parser 202, the example base system identification controller 204, the example vulnerability detector 206, the example target system identification controller 208, the secure operation generation controller 210, the known vulnerabilities and/or known remediation database 212, and/or, more generally, the example security controller 108 of FIG. 2 may be implemented by hardware, software, firmware and/or any combination of hardware, software and/or firmware. Thus, for example, any of the example program parser 202, the example base system identification controller 204, the example vulnerability detector 206, the example target system identification controller 208, the secure operation generation controller 210, the known vulnerabilities and/or known remediation database 212, and/or, more generally, the example security controller 108 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example program parser 202, the example base system identification controller 204, the example vulnerability detector 206, the example target system identification controller 208, the secure operation generation controller 210, the known vulnerabilities and/or known remediation database 212, and/or, more generally, the example security controller 108 of FIG. 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example security controller 108 of FIG. 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example hardware logic, machine readable instructions, hardware implemented state machines, and/or any combination thereof for implementing the security controller 108 of FIGS. 1 and 2 are shown in FIGS. 3 and 4. The machine readable instructions may be one or more executable programs or portion(s) of an executable program for execution by a computer processor such as the processor 512 shown in the example processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowcharts illustrated in FIGS. 3 and 4, many other methods of implementing the example security controller 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3 and 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions 300 which may be executed to implement the example security controller 108 of FIGS. 1 and 2 to generate an example secure representation of an algorithm in an example target programming language. The machine-readable instructions 300 begin at block 302 where the program parser 202, and/or, more generally, the security controller 108, identifies an algorithm that is candidate to be secured. For example, the program parser 202 can identify an algorithm that is suitable for use with a DSL.

In the example of FIG. 3, at block 304, the program parser 202, and/or, more generally, the security controller 108, identifies the semantics of a candidate algorithm. For example, the program parser 202 can perform semantic analysis on the candidate algorithm. At block 306, the base system identification controller 204, and/or, more generally, the security controller 108, identifies the base programming language in which the candidate algorithm is programmed. At block 308, the base system identification controller 204, and/or, more generally, the security controller 108, identifies the base hardware platform at which the candidate algorithm was programmed to be executed.

In the example illustrated in FIG. 3, at block 310, the program parser 202, and/or, more generally, the security controller 108, parses the base programming language representation of the candidate algorithm to identify native BPL operators, native BPL libraries/APIs, and/or third-party libraries/APIs. At block 312, based on the identified native BPL operators, native BPL libraries/APIs, and/or third-party libraries/APIs, the vulnerability detector 206, and/or, more generally, the security controller 108, identifies one or more vulnerabilities associated with the BPL representation of the candidate program and the BHP. At block 314, the target system identification controller 208, and/or, more generally, the security controller 108, identifies a target programming language in which to secure the candidate algorithm. At block 316, the target system identification controller 208, and/or, more generally, the security controller 108, identifies a target hardware platform at which the secured version of the candidate algorithm is to be executed. At block 318, the security controller 108 converts the BPL representation of the candidate algorithm to a secured version of the algorithm represented in the TPL. Detailed example machine readable instructions to convert the BPL representation of the candidate algorithm to a secured version of the algorithm represented in the TPL are illustrated and described in connection with FIG. 4.

In the example of FIG. 3, at block 320, the target system identification controller 208, and/or, more generally, the security controller 108, determines whether there are additional target programming languages in which to secure the candidate algorithm. In response to the target system identification controller 208 determining that there are additional TPL in which to secure the candidate algorithm (block 320: YES), the machine-readable instructions 300 proceed to block 316. In response to the target system identification controller 208 determining that there are not additional TPL in which to secure the candidate algorithm (block 320: NO), the machine-readable instructions 300 proceed to block 322.

In the illustrated example of FIG. 3, at block 322, the target system identification controller 208, and/or, more generally, the security controller 108, determines whether there are additional target hardware platforms at which to execute the secured version of the candidate algorithm. In response to the target system identification controller 208 determining that there are additional target hardware platforms at which to execute the secured version of the candidate algorithm (block 322: YES), the machine-readable instructions 300 proceed to block 314. In response to the target system identification controller 208 determining that there are not additional target hardware platforms at which to execute the secured version of the candidate algorithm (block 322: NO), the machine-readable instructions 300 proceed to block 324.

In the example of FIG. 3, at block 324, the program parser 202, and/or, more generally, the security controller 108, determines whether there are additional candidate algorithms to secure. In response to the program parser 202 determining that there are additional candidate algorithms to secure (block 324: YES), the machine-readable instructions 300 proceed to block 302. In response to the program parser 202 determining that there are additional candidate algorithms to secure (block 324: NO), the machine-readable instructions 300 terminate.

FIG. 4 is a flowchart representative of example machine readable instructions 318 which may be executed to implement the example security controller 108 of FIGS. 1 and 2 to convert a base programming language representation of an algorithm to a secured target programming language representation of the algorithm. The machine-readable instructions 318 begin at block 402 where the base system identification controller 204, and/or, more generally, the security controller 108, determines whether the BPL is the same as (e.g., within a threshold of similarity to) the TPL. In response to the base system identification controller 204 determining that the BPL is the same as the TPL (block 402: YES), the machine-readable instructions 318 proceed to block 410. In response to the base system identification controller 204 determining that the BPL is not the same as the TPL (block 402: NO), the machine-readable instructions 318 proceed to block 404.

In the example of FIG. 4, at block 404, the secure operation generation controller 210, and/or, more generally, the security controller 108, converts the BPL instructions (e.g., the BPL instructions 104), to a DSL representation of the algorithm. At block 406, the vulnerability detector 206, and/or, more generally, the security controller 108, identifies potential vulnerabilities associated with the TPL. At block 408, the secure operation generation controller 210, and/or, more generally, the security controller 108, generates DSL syntax to secure and/or otherwise remediate the potential vulnerabilities associated with the TPL. For example, the secure operation generation controller 210 can perform lambda calculus to generate DSL syntax to secure and/or otherwise remediate the potential vulnerabilities associated with the TPL.

In the illustrated example of FIG. 4, at block 410, the base system identification controller 204, and/or, more generally, the security controller 108, determines whether the BHP is the same as (e.g., within a threshold of similarity to) the THP. In response to the base system identification controller 204 determining that the BHP is the same as the THP (block 410: YES), the machine-readable instructions 318 proceed to block 420. In response to the base system identification controller 204 determining that the BHP is not the same as the THP (block 410: NO), the machine-readable instructions 318 proceed to block 412.

In the example of FIG. 4, at block 412, the secure operation generation controller 210, and/or, more generally, the security controller 108, determines whether the BPL instructions (e.g., the BPL instructions 104) have been previously converted to a DSL representation of the algorithm. If the secure operation generation controller 210 determines that the BPL instructions (e.g., the BPL instructions 104) have been previously converted to a DSL representation of the algorithm (block 412: YES), the machine-readable instructions 318 proceed to block 416. If the secure operation generation controller 210 determines that the BPL instructions (e.g., the BPL instructions 104) have not been previously converted to a DSL representation of the algorithm (block 412: NO), the machine-readable instructions 318 proceed to block 414.

In the example illustrated in FIG. 4, at block 414, the secure operation generation controller 210, and/or, more generally, the security controller 108, converts the BPL instructions (e.g., the BPL instructions 104), to a DSL representation of the algorithm. At block 416, the vulnerability detector 206, and/or, more generally, the security controller 108, identifies potential vulnerabilities associated with the THP. At block 418, the secure operation generation controller 210, and/or, more generally, the security controller 108, generates DSL syntax to secure and/or otherwise remediate the potential vulnerabilities associated with the THP. For example, the secure operation generation controller 210 can perform lambda calculus to generate DSL syntax to secure and/or otherwise remediate the potential vulnerabilities associated with the THP. At block 420, the secure operation generation controller 210, and/or, more generally, the security controller 108, generates a TPL representation of the secured candidate algorithm. After block 420, the machine-readable instructions 318 return to the machine-readable instructions 300 at block 320.

FIG. 5 is a block diagram of an example processor platform 500 structured to execute the instructions of FIGS. 3 and 4 to implement the security controller 108 of FIGS. 1 and 2. The processor platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor 512 may be a semiconductor based (e.g., silicon based) device. In this example, the processor 512 implements the example program parser 202, the example base system identification controller 204, the example vulnerability detector 206, the example target system identification controller 208, the example secure operation generation controller 210, the known vulnerabilities and/or known remediation database 212, and/or, more generally, the security controller 108.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIGS. 3 and 4 may be stored in the mass storage device 528, in the volatile memory 514, in the non-volatile memory 516, and/or on a removable non-transitory computer readable storage medium such as a CD or DVD.

From the foregoing, it will be appreciated that example methods, apparatus, and articles of manufacture have been disclosed that improve security of computer programs using code abstraction. The disclosed methods, apparatus, and articles of manufacture reduce the computational search space for recreating code in a lower level language (e.g., the TPL instructions 106). Additionally, the disclosed methods, apparatus, and articles of manufacture increase the security of programs and increases the number of devices for which secure code can be programmed. The disclosed methods, apparatus, and articles of manufacture improve the efficiency of using a computing device by reducing vulnerabilities to malicious attacks. The disclosed methods, apparatus, and articles of manufacture prevent malicious attacks such as those that exploit buffer overruns, those that exploit dereferenced pointers, and/or cache-based side channel attacks facilitated via instruction speculation. The disclosed methods, apparatus and articles of manufacture are accordingly directed to one or more improvement(s) in the functioning of a computer.

Example methods, apparatus, systems, and articles of manufacture to improve security of computer programs using code abstraction are disclosed herein. Further examples and combinations thereof include the following:

Example 1 includes an apparatus to improve security of computer programs using code abstraction, the apparatus comprising a program parser to parse a first representation of an algorithm in a base language for an operator associated with the base language, a vulnerability detector to, based on the operator, identify a vulnerability in the first representation of the algorithm, a target identification controller to identify a target language to represent the algorithm, and a security controller to convert the first representation of the algorithm in the base language to a second representation of the algorithm in the target language to remediate the vulnerability.

Example 2 includes the apparatus of example 1, wherein the vulnerability detector is to identify a vulnerability associated with the second representation of the algorithm.

Example 3 includes the apparatus of example 2, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

Example 4 includes the apparatus of example 2, further including a secure operation generation controller to in response to the base language being different than the target language, convert the first representation of the algorithm to a third representation of the algorithm in a domain specific language (DSL), and generate DSL syntax to remediate the vulnerability associated with the second representation of the algorithm.

Example 5 includes the apparatus of example 4, wherein the secure operation generation controller is to generate a mapping between the third representation of the algorithm including the DSL syntax and the second representation of the algorithm.

Example 6 includes the apparatus of example 1, wherein the vulnerability detector is to identify a vulnerability associated with execution of the algorithm at a target hardware platform.

Example 7 includes the apparatus of example 6, further including a secure operation generation controller to in response to a base hardware platform at which to execute the first representation of the algorithm being different than the target hardware platform, convert the first representation of the algorithm to a third representation of the algorithm in a domain specific language (DSL), and generate DSL syntax to remediate the vulnerability associated with the execution of the algorithm at the target hardware platform.

Example 8 includes the apparatus of example 7, wherein the secure operation generation controller is to generate a mapping between the third representation of the algorithm including the DSL syntax and the second representation of the algorithm.

Example 9 includes a non-transitory computer readable medium comprising instructions that, when executed, cause one or more processors to at least parse a first representation of an algorithm in a base language for an operator associated with the base language, based on the operator, identify a vulnerability in the first representation of the algorithm, identify a target language to represent the algorithm, and convert the first representation of the algorithm in the base language to a second representation of the algorithm in the target language to remediate the vulnerability.

Example 10 includes the non-transitory computer readable medium of example 9, wherein the instructions cause the one or more processors to identify a vulnerability associated with the second representation of the algorithm.

Example 11 includes the non-transitory computer readable medium of example 10, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

Example 12 includes the non-transitory computer readable medium of example 10, wherein the instructions cause the one or more processors to in response to the base language being different than the target language, convert the first representation of the algorithm to a third representation of the algorithm in a domain specific language (DSL), and generate DSL syntax to remediate the vulnerability associated with the second representation of the algorithm.

Example 13 includes the non-transitory computer readable medium of example 12, wherein the instructions cause the one or more processors to generate a mapping between the third representation of the algorithm including the DSL syntax and the second representation of the algorithm.

Example 14 includes the non-transitory computer readable medium of example 9, wherein the instructions cause the one or more processors to identify a vulnerability associated with execution of the algorithm at a target hardware platform.

Example 15 includes the non-transitory computer readable medium of example 14, wherein the instructions cause the one or more processors to in response to a base hardware platform at which to execute the first representation of the algorithm being different than the target hardware platform, convert the first representation of the algorithm to a third representation of the algorithm in a domain specific language (DSL), and generate DSL syntax to remediate the vulnerability associated with the execution of the algorithm at the target hardware platform.

Example 16 includes the non-transitory computer readable medium of example 15, wherein the instructions cause the one or more processors to generate a mapping between the third representation of the algorithm including the DSL syntax and the second representation of the algorithm.

Example 17 includes an apparatus to improve security of computer programs using code abstraction, the apparatus comprising means for parsing a program to parse a first representation of an algorithm in a base language for an operator associated with the base language, means for detecting vulnerabilities to, based on the operator, identify a vulnerability in the first representation of the algorithm, means for identifying a target system to identify a target language to represent the algorithm, and means for securing code to convert the first representation of the algorithm in the base language to a second representation of the algorithm in the target language to remediate the vulnerability.

Example 18 includes the apparatus of example 17, wherein the means for detecting vulnerabilities is to identify a vulnerability associated with the second representation of the algorithm.

Example 19 includes the apparatus of example 18, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

Example 20 includes the apparatus of example 18, further including means for generating secure operations to in response to the base language being different than the target language, convert the first representation of the algorithm to a third representation of the algorithm in a domain specific language (DSL), and generate DSL syntax to remediate the vulnerability associated with the second representation of the algorithm.

Example 21 includes the apparatus of example 20, wherein the means for generating secure operations is to generate a mapping between the third representation of the algorithm including the DSL syntax and the second representation of the algorithm.

Example 22 includes the apparatus of example 17, wherein the means for detecting vulnerabilities is to identify a vulnerability associated with execution of the algorithm at a target hardware platform.

Example 23 includes the apparatus of example 22, further including means for generating secure operations to in response to a base hardware platform at which to execute the first representation of the algorithm being different than the target hardware platform, convert the first representation of the algorithm to a third representation of the algorithm in a domain specific language (DSL), and generate DSL syntax to remediate the vulnerability associated with the execution of the algorithm at the target hardware platform.

Example 24 includes the apparatus of example 23, wherein the means for generating secure operations is to generate a mapping between the third representation of the algorithm including the DSL syntax and the second representation of the algorithm.

Example 25 includes a method to improve security of computer programs using code abstraction, the method comprising parsing a first representation of an algorithm in a base language for an operator associated with the base language, based on the operator, identifying a vulnerability in the first representation of the algorithm, identifying a target language to represent the algorithm, and converting the first representation of the algorithm in the base language to a second representation of the algorithm in the target language to remediate the vulnerability.

Example 26 includes the method of example 25, further including identifying a vulnerability associated with the second representation of the algorithm.

Example 27 includes the method of example 26, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

Example 28 includes the method of example 26, further including in response to the base language being different than the target language, converting the first representation of the algorithm to a third representation of the algorithm in a domain specific language (DSL), and generating DSL syntax to remediate the vulnerability associated with the second representation of the algorithm.

Example 29 includes the method of example 28, further including generating a mapping between the third representation of the algorithm including the DSL syntax and the second representation of the algorithm.

Example 30 includes the method of example 25, further including identifying a vulnerability associated with execution of the algorithm at a target hardware platform.

Example 31 includes the method of example 30, further including in response to a base hardware platform at which to execute the first representation of the algorithm being different than the target hardware platform, converting the first representation of the algorithm to a third representation of the algorithm in a domain specific language (DSL), and generating DSL syntax to remediate the vulnerability associated with the execution of the algorithm at the target hardware platform.

Example 32 includes the method of example 31, further including generating a mapping between the third representation of the algorithm including the DSL syntax and the second representation of the algorithm.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

The status of the claims:

1. An apparatus to improve security of computer programs using code abstraction, the apparatus comprising:
a program parser to parse a first representation of an algorithm in a base language for an operator associated with the base language;
a vulnerability detector to, based on the operator, identify a vulnerability in the first representation of the algorithm;
a target identification controller to identify a target language to represent the algorithm; and
a security controller to convert the first representation of the algorithm in the base language to a second representation of the algorithm in the target language to remediate the vulnerability.

2. The apparatus of claim 1, wherein the vulnerability detector is to identify a vulnerability associated with the second representation of the algorithm.

3. The apparatus of claim 2, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

4. The apparatus of claim 2, further including a secure operation generation controller to:
in response to the base language being different than the target language, convert the first representation of the algorithm to a third representation of the algorithm in a domain specific language (DSL); and
generate DSL syntax to remediate the vulnerability associated with the second representation of the algorithm.

5. The apparatus of claim 4, wherein the secure operation generation controller is to generate a mapping between the third representation of the algorithm including the DSL syntax and the second representation of the algorithm.

6. The apparatus of claim 1, wherein the vulnerability detector is to identify a vulnerability associated with execution of the algorithm at a target hardware platform.

7. The apparatus of claim 6, further including a secure operation generation controller to:
in response to a base hardware platform at which to execute the first representation of the algorithm being different than the target hardware platform, convert the first representation of the algorithm to a third representation of the algorithm in a domain specific language (DSL); and
generate DSL syntax to remediate the vulnerability associated with the execution of the algorithm at the target hardware platform.

8. The apparatus of claim 7, wherein the secure operation generation controller is to generate a mapping between the third representation of the algorithm including the DSL syntax and the second representation of the algorithm.

9. A non-transitory computer readable medium comprising instructions that, when executed, cause one or more processors to at least:
parse a first representation of an algorithm in a base language for an operator associated with the base language;
based on the operator, identify a vulnerability in the first representation of the algorithm;
identify a target language to represent the algorithm; and
convert the first representation of the algorithm in the base language to a second representation of the algorithm in the target language to remediate the vulnerability.

10. The non-transitory computer readable medium of claim 9, wherein the instructions cause the one or more processors to identify a vulnerability associated with the second representation of the algorithm.

11. The non-transitory computer readable medium of claim 10, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

12. The non-transitory computer readable medium of claim 10, wherein the instructions cause the one or more processors to:
in response to the base language being different than the target language, convert the first representation of the algorithm to a third representation of the algorithm in a domain specific language (DSL); and
generate DSL syntax to remediate the vulnerability associated with the second representation of the algorithm.

13. The non-transitory computer readable medium of claim 12, wherein the instructions cause the one or more processors to generate a mapping between the third representation of the algorithm including the DSL syntax and the second representation of the algorithm.

14. The non-transitory computer readable medium of claim 9, wherein the instructions cause the one or more processors to identify a vulnerability associated with execution of the algorithm at a target hardware platform.

15. The non-transitory computer readable medium of claim 14, wherein the instructions cause the one or more processors to:
in response to a base hardware platform at which to execute the first representation of the algorithm being different than the target hardware platform, convert the first representation of the algorithm to a third representation of the algorithm in a domain specific language (DSL); and
generate DSL syntax to remediate the vulnerability associated with the execution of the algorithm at the target hardware platform.

16. (canceled)

17. An apparatus to improve security of computer programs using code abstraction, the apparatus comprising:
means for parsing a program to parse a first representation of an algorithm in a base language for an operator associated with the base language;
means for detecting vulnerabilities to, based on the operator, identify a vulnerability in the first representation of the algorithm;
means for identifying a target system to identify a target language to represent the algorithm; and
means for securing code to convert the first representation of the algorithm in the base language to a second representation of the algorithm in the target language to remediate the vulnerability.

18. The apparatus of claim 17, wherein the means for detecting vulnerabilities is to identify a vulnerability associated with the second representation of the algorithm.

19. The apparatus of claim 18, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

20. The apparatus of claim 18, further including means for generating secure operations to:
in response to the base language being different than the target language, convert the first representation of the algorithm to a third representation of the algorithm in a domain specific language (DSL); and
generate DSL syntax to remediate the vulnerability associated with the second representation of the algorithm.

21. The apparatus of claim 20, wherein the means for generating secure operations is to generate a mapping between the third representation of the algorithm including the DSL syntax and the second representation of the algorithm.

22-24. (canceled)

25. A method to improve security of computer programs using code abstraction, the method comprising:
parsing a first representation of an algorithm in a base language for an operator associated with the base language;
based on the operator, identifying a vulnerability in the first representation of the algorithm;
identifying a target language to represent the algorithm; and
converting the first representation of the algorithm in the base language to a second representation of the algorithm in the target language to remediate the vulnerability.

26. The method of claim 25, further including identifying a vulnerability associated with the second representation of the algorithm.

27. The method of claim 26, wherein one or more of the vulnerability in the first representation of the algorithm and the vulnerability associated with the second representation of the algorithm include at least one of buffer overruns, invalid pointer dereferences, third-party application programming interface (API) calls using opaque data structures, or use of optimized versions of third-party APIs.

28. The method of claim 26, further including:
in response to the base language being different than the target language, converting the first representation of the algorithm to a third representation of the algorithm in a domain specific language (DSL); and
generating DSL syntax to remediate the vulnerability associated with the second representation of the algorithm.

29. The method of claim 28, further including generating a mapping between the third representation of the algorithm including the DSL syntax and the second representation of the algorithm.

30-32. (canceled)
